(19) United States
(12) Patent Application Publication
(10) Pub. No.: US 2007/0191251 A1
(43) Pub. Date: Aug. 16, 2007

(54) Bleach-free detergent tablet

(75) Inventors: Joel Geny, Brussels (BE); Michael Alan John Moss, Woluwe St. Pierre (BE)

Correspondence Address: THE PROCTER & GAMBLE COMPANY;INTELLECTUAL PROPERTY DIVISION - WEST BLDG., WINTON HILL BUSINESS CENTER - BOX 412, 6250 CENTER HILL AVENUE, CINCINNATI, OH, 45224, US

(73) Assignee: The Procter & Gamble Company

(21) Appl. No.: 11/706,613

(22) Filed: Feb. 15, 2007

(30) Foreign Application Priority Data
Feb. 15, 2006 (EP) 06 101 715.8

(51) Int. Cl. C11D 17/00

(52) U.S. Cl. 510/424; 510/447

(57) ABSTRACT

The present invention relates to a bleach-free detergent tablet for use in the laundering of coloured garments. The tablet composition provides a pH through the wash of less than 9, comprises at least one surfactant and has a normalised soil removal index of greater than minus 2.

### FIELD OF THE INVENTION

The present invention relates to detergent tablets having improved bleachable-soil removal from coloured garments without the use of bleaching agents.

### BACKGROUND OF THE INVENTION

Compositions in form of tablets, e.g., especially for a laundry or an automatic dishwashing operation, become increasingly popular with consumers as they offer simple dosing, easy storage and handling. Also for detergent manufacturers, tablet compositions have many benefits such as reduced transportation costs, handling costs and storage costs. Tablets are typically formed by compression of the various components. The tablets produced must be sufficiently robust to be able to withstand handling and transportation without sustaining damage. In addition, the tablets must also dissolve quickly so that the detergent components are released into the wash water as soon as possible at the beginning of the wash cycle. Such performance aspects are an important feature of the detergent tablets, and although they are not necessarily the focus of the present invention, they are inherently a part of the background of the present invention.

Laundry granule or tablet detergents historically have comprised a bleaching agent for removing strains, especially highly coloured, bleachable soils. However there is also the concern that bleaching agents used in laundry detergents may also bleach the colour from fabrics to some extent. It has therefore been the objective of the Applicant to develop laundry detergent tablets that provide good bleachable-soil removal but do not contain bleach. Historically, laundry detergents have been formulated at high pH. High pH, greater than 9 has been shown to provide better cleaning results than low pH. Bleaching agents also require a high pH to function efficiently. Furthermore, when it comes to detergent tablets, alkaline ingredients, such as carbonate and phosphate, have historically been used as processing. Thus detergent tablets, even those not comprising bleach were formulated at high pH, for process and cleaning ability. However, it has been found that in fact high pH can alter the chemistry of a highly coloured soil, resulting in the darkening of the soil on the garment, making it more visible. It has thus been the object of the present invention to develop a detergent composition in tablet form that does not comprise bleach, but that does effectively remove bleachable, highly coloured soils, without detrimentally affecting the colour of the garment.

### SUMMARY OF THE INVENTION

According to the present invention there is provided a bleach-free detergent tablet comprising a composition providing a pH through the wash of less than 9, comprising at least one surfactant and having an average normalised soil removal index of greater than minus 2.

According to another aspect of the present invention there is provided a bleach-free detergent tablet kit comprising one or more tablets, wherein the composition of the tablet provides a pH through the wash of less than 9, comprises at least one surfactant and wherein the dosage weight of the kit is less than 75 g.

### DETAILED DESCRIPTION OF THE INVENTION

The articles of the present invention have sufficient hardness to survive handling and transportation, will rapidly dissolve in water during a short cycle washing and/or rinsing process without leaving residue.

### Detergent Tablet

The detergent tablets of the present invention are made using known techniques for making tablets as discussed later. The tablets are made from compressed particles, granules or powders. The tablets may comprise I or more different regions. Providing different regions allows the manufacturer to include chemically or physically reactive ingredients in the tablet formulations but in different regions so as to reduce or eliminate any disadvantageous interactions. More preferably there consists a compacted region of the detergent tablet which is usually referred to as the core and a second, discrete, region that will be in the form of a single or a plurality of coating, insert, dimple, beads, particles, gel layer or phase, smooth phase etc.

The different regions can either have the same or different colors. Multi-layer tablets having 2 or 3 layers are preferred. Single- and multi-layer tablets having excavations and/or cavities and/or holes in all sorts of geometrical forms are also included in the present invention. Particularly preferred are tablets in which embedded geometrical shapes such as hemispheres protrude from the surface of the tablet.

In a preferred embodiment, the detergent tablet herein comprise two regions, the first region in the form of a shaped body having at least one mold therein and the second region in the form of a compressed or shaped body contained, for example by physical or chemical adhesion, within the mould of the first region. The discrete second region preferably comprises agents selected from the group consisting of perfume particle, fabric softening agent, a binder, a dissolution aid, a builder, an alkalinity source, a dye, a free perfume and/or an effervescent system (as described below in more details) and mixtures thereof. More preferably selected from the group consisting of perfume particles, dissolution aid, dye, effervescent system and mixtures thereof. Even more preferably perfume particles.

The tablets of the present invention are characterised by having a low pH. The tablets provide a pH through the wash of less than 9. More preferably a pH through the wash of between 7 and 8.9 and most preferably between 8.3 and 8.7.

One benefit of successfully formulating a detergent at low pH is that other ingredients that are either only efficient at high pH or are added to stabilise a high pH formula can be removed. In order to maintain the same weight of tablet, the removal of these ingredients can be replaced by sulphate. Sulphate, although not providing any cleaning efficacy, is an economical ingredient, allowing the manufacturer to decrease the cost of the formula. It may be important to maintain the tablet weight as costly tablet making equipment does not have to be replaced. Thus in one embodiment of the present invention the detergent tablet composition comprises greater than 10% alkaline or alkaline earth metal sulphate, more preferably greater than 15% alkaline or alkaline earth metal sulphate.

Alternatively, the elimination of bleach and ingredients that are efficient only at high pH or are used to stabilise a high pH formula in tablets according to the present invention, means that the tablet dosage weight can be reduced. Whilst requiring initial capital outlay in new or modified equipment, the eventual cost saving is greater as there is less need for fillers, such as sulphate. Thus in an alternative embodiment of the present invention the dosage weight of the detergent tablet kit is less than 75 g, more preferably less than 70 g, most preferably less than 65 g.

### Measurement of the pH through the Wash:

A Sartorius PT-10 pH meter, available from Qlab N.V., is used to measure the pH. Before taking any measurement the equipment is calibrated with standard solution of pH 4, 7 and 10 (available from Merck ref 1.09435.1000, 1.09439.1000 and 1.09438.1000 respectively). 10 min after the wash cycle at 30° C. has started the washing machine door is open via the manual opening device at the bottom left of the washing machine (Miele Softronic W467). The electrode of the pH meter is put directly inside the wash solution of the drum.

### Surfactant

The composition of the present invention comprises at least one surfactant. Preferably the composition comprises at least two or more surfactants. The total surfactant concentration is preferably from 1% to 80% by weight, more preferably from 10% to 70% by weight, most preferably from 20% to 60% by weight of the composition. Suitable surfactants are selected from anionic, cationic, non-ionic, ampholytic, zwitterionic surfactants and mixtures thereof.

A typical listing of anionic, nonionic, amphoteric and zwitterionic classes, and species of these surfactants, is given in U.S. Pat. No. 3,929,678 issued to Laughlin and Heuring on Dec. 30, 1975. A list of suitable cationic surfactants is given in U.S. Pat. No. 4,259,217 issued to Murphy on Mar. 31, 1981. A listing of surfactants typically included in laundry detergent compositions is given for example, in EP-A-0414 549 and PCT Applications No.s WO 93/08876 and WO 93/08874. Further suitable detergent active compounds are available and are fully described in WO 02/31100 published on Apr. 18, 2002 and assigned to P&G and in the literature, e.g., in “Surface-active agents and detergents”, Vol. I and II, by Schwartz, Perry and Berch.

Preferred surfactants include anionic, non-ionic and cationic surfactants and mixtures thereof. Preferably the detergent includes a non-ionic surfactant. Preferably the detergent includes an anionic surfactant. Preferably the detergent includes a cationic surfactant. Preferably the composition comprises mixtures of anionic and non-ionic surfactants. A preferred anionic surfactant is a linear alkyl benzene sulphonate anionic surfactant or taloalkyl sulphate or mixture thereof. Preferred non-ionic surfactants are selected from ethoxylated alcohol nonionic surfactants, more preferably alkyl C8-22 phenol ethylene oxide condensates, primary and secondary alcohol ethoxylates average 5-20 moles of ethylene oxide per mol of alcohol. A preferred example is Lutensol 7EO from BASF.

### Soil Removal Index: Bleachable Soil Removal

The tablets of the present invention are so formulated as to provide exceptional cleaning on coloured fabrics. More particularly these present tablets are surprisingly good at cleaning highly coloured soils. These soils are often referred to as bleachable soils or stains as bleach can remove the visibility of the soil by bleaching the colour from the stain. They do not however remove the soil/stain from the fabric. It has been found, to our surprise that a composition comprising no bleach and having low pH is highly effective at removing highly coloured, bleachable soils from coloured garments, without damaging the fabric or removing colour there from.

The bleachable-soil removal index (SRI), as used herein, is a measure of the ability of a detergent composition to remove highly-coloured, bleachable soils from a fabric. The data has been normalised by comparison of the SRI of compositions at higher pH with the SRI of the composition (composition C) according to the present invention. The compositions at higher pH can be seen to provide an average Soil Removal Index of less than minus 2 on the variety of stains tested. The test protocol is reliable and reproducible and is commonly used in the industry by detergent manufacturers and consumer institutes a like. The test is aimed to represent the real consumer wash conditions. The equipment used is standard and freely available on the market.

### Soil Removal Index Test Method: b

This protocol provides an absolute and comparative stain removal assessment of 7 detergents via reflectance analysis. The test conditions are as follows:

Miele Softronic W467 washing machines are used at 30° C. using the “Crease Resistant” washing cycle (1 hour wash cycle in total). The ‘fuzzy logic’ feature is deactivated by the Miele engineer in order to ensure the same volume of water per wash cycle. The water hardness is adjusted to 21 gpg by topping up the tap water with the required amount of Ca²⁺/Mg²⁺ at a 3/1 ratio.

A stain sets of 7 bleachable stains, is added to the washing machine with 5 soiled swatches (Available from WFK—SBL 2004; 8 g of soil per swatch) and topped with ballast load made of clean 100% white flat cotton kitchen towels. The total load weight is 3 kg and is measured when dry. The same is repeated in 6 machines for all 6 products being tested. The machines are used 6 times sequentially in order to have a total of 6 stain set replications per product.

Before starting the test the ballast load is preconditioned in a Miele Softronic W467 washing machine using the normal cycle for White as follows: 30 C wash with 50 g of a light duty detergent, containing low bleach, low enzyme, normally used to wash delicate garments. In the test herein we used Dreft regular powder, 3 washes at 90° C. with 50 g Dreft regular powder (or other light duty detergent as above) and 3 washes at 90° C. without detergent. The ballast load is then dried in a Miele T490 using the extra dry cycle.

Before the first cycle starts, the dry ballast load is run though the rinse cycle in order to wet the load (not the stain set) at 21 gpg water hardness. The same ballast load is reused wet with the next product(s) for the next cycle(s) without intermediate drying.

To load the machines, add ¼ of the ballast load, then 2 soiled swatches, the 2^{nd} quarter of the ballast is then added followed by the stain set and 1 soiled swatch, the 3^{rd} quarter of the ballast is then add followed by the last 2 soiled swatches, and finally the last part of the ballast load. See table 1 for the washing machine rotation sequence.

2 tablets of each product (the recommended dosage) are added via the dispenser or in the drum depending on the manufacturer recommendation. When the wash cycle is finished all stains are line dried next to each other for a minimum of 6 h, indoors at room temperature.

TABLE 1

| | Machine | Machine | Machine | Machine | Machine | Machine | Machine |
|---|---|---|---|---|---|---|---|
| | #1 | #2 | #3 | #4 | #5 | #6 | #7 |
| Cycle 1 | 1a | 1b | 1c | 1d | 1e | 1f | 1g |
| Cycle 2 | 2g | 2a | 2b | 2c | 2d | 2e | 2f |
| Cycle 3 | 3f | 3g | 3a | 3b | 3c | 3d | 3e |
| Cycle 4 | 4e | 4f | 4g | 4a | 4b | 4c | 4d |
| Cycle 5 | 5d | 5e | 5f | 5g | 5a | 5b | 5c |
| Cycle 6 | 6c | 6d | 6e | 6f | 6g | 6a | 6b |

Stain set Coding:
First digit = code number of the stain set replicate
Second digit = code letter of the detergent

Stain sets are ordered from CFT an independent stain supplier: Center For Testmaterials BV, PO Box 120, 3133 KT Vlaardingen, Nederland. The selected stains are a cross section of the available testable highly coloured soils and stains.

| Stain type | Code |
|---|---|
| Chocolate Drink | CFT CS44 |
| Freshly Boiled Tea (pickwick) (batch stain) | CFT CS47 |
| Freshly brewed coffee, black expresso (batch stain) | CFT CS50 |
| Chocolate ice cream (handmade stain) | CFT CH009 |
| Red Wine (handmade stain) | CFT CH026 |
| Apple Freshly Squeezed (handmade stain) | CFT CH003 |
| Peach concentrate, 50—50 with water (handmade stain) | CFT CH025 |

The WFK SBL 2004 soiled swatches are ordered from an independent supplier at: wfk Cleaning Technology Research Institute, Campus Fichtenhain 11, D-47807 Krefeld, Germany.

When the stains are dried, they are analyzed using a Minolta spectrophotometer and the “Polaris White Star” software version 1.1 supplied by Axiphos GmbH. All measurements are taken within 48 h after the last washing cycles is finished. All stains are analyzed on the same day. The spectrophotometer measures the Y-value reflectance of the washed stain versus the unwashed stain reference without UV filter at 420 nm and 2 measuring point per stains. Once all replicates for all products have been analysed an average % stain removal is calculated for each stain and detergent tested. As each detergent differs in its cleaning ability on different soils we have compared each detergents capability to remove a given soil in comparison to the reference formulation of the present tablets, composition C. This data is termed the normalised soil removal index. Normalised SRI for any given detergent is calculated as follows: SRI for detergent—SRI for detergent C (reference). The average of this data is then calculated to give the average SRI for the detergent.

Stain Removal Index (in %)=(C−B)×100/(A−B)

Where A=white sample reflectance before washing an d soiling, B=soiled sample reflectance before washing, C=soiled sample reflectance after washing.

| | | | C | | | F | |
|---|---|---|---|---|---|---|---|
| | | B | Nil | D | E | Unilever | G |
| | A | Nil | Bleach | Nil | Unilever | Persil | Henkel |
| | Bleach | Bleach | low pH | Bleach | Persil | Color (nil- | Persil |
| | High pH | high pH | Reference | low pH | Color (P) | P) | Color |
| Batch no | | | | | 52587P3 | 5217NCA | 015242F |
| Bought from: | | | | | (TESCO | (TESCO | (Carrefour |
| Date bought | | | | | Newcastle | Newcastle | Strombeek |
| | | | | | 04/10/06) | 04/10/06) | 19/12/06) |
| Tablet dosage | 80 | 80 | 80 | 80 | 72 | 84 | 70 |
| per wash (g) | | | | | | | |
| Tablet | | | | | | | |
| Composition | (%) | (%) | (%) | (%) | | | |
| Nonionic | 3.0 | 3.0 | 3.0 | 3.5 | Accurate formulate details | | |
| Anionic | 12.5 | 12.5 | 12.5 | 13.5 | unavailable | | |
| Zeolite | 30.0 | 30.0 | 30.0 | 17.0 | | | |
| Silicate | 0.5 | 0.5 | 0.5 | 0.5 | | | |
| tetra sodium | 0.6 | 0.6 | 0.6 | 0.6 | | | |
| salt of | | | | | | | |
| diphosphonic | | | | | | | |
| acid | | | | | | | |
| acrilic/maleic | 1.2 | 1.2 | 1.2 | 0.0 | | | |
| copolymer | | | | | | | |
| Cationic | 0.7 | 0.7 | 0.7 | | | | |
| polymer | | | | | | | |
| Protease | 0.3 | 0.3 | 0.3 | 0.3 | | | |
| Suds suppressor | 1.0 | 1.0 | 1.0 | 1.0 | | | |
| Sodium Acetate | 4.0 | 4.0 | 4.0 | 4.0 | | | |
| Sodium | | | | | | | |
| Carbonate | 10.0 | 20.0 | 6.0 | 7.0 | | | |
| Citrate | 6.7 | 6.7 | | 10.0 | | | |
| Citric Acid | | | 5.0 | 1.0 | | | |
| Percarbonate | 20.0 | | | | | | |
| Clay | | | | 5.0 | | | |
| Binder/Coating | | | | 6.0 | | | |
| Miscellanous/ | 10.0 | 10.0 | 10.0 | 10.0 | | | |
| moisture | | | | | | | |
| sulphate | balance | balance | balance | balance | | | |
| | to 100 | to 100 | to 100 | to 100 | | | |
| pH tru the | 8.5 | 10.0 | 8.5 | 8.6 | 9.6 | 9.8 | 9.1 |
| wash after 10′ | | | | | | | |
| 30 C. | | | | | | | |

Normalised SRI

| | | | | | | F | |
|---|---|---|---|---|---|---|---|
| | | B | C | D | E | Unilever | G |
| | A | Nil | Nil | Nil | Unilever | Persil | Henkel |
| | Bleach | Bleach | Bleach | Bleach | Persil | Color (nil- | Persil |
| | High pH | high pH | low pH | low pH | Color (P) | P) | Color |
| chocolate | −9 | −11 | 0 | 2 | 1 | −5 | −3 |
| drink | | | | | | | |
| Tea | 0 | −35 | 0 | −1 | −1 | −23 | −15 |
| Expresso | 8 | −7 | 0 | −1 | −1 | −8 | −4 |
| Coffee | | | | | | | |
| Chocolate ice | −14 | −7 | 0 | 7 | −7 | −8 | −7 |
| cream | | | | | | | |
| Red Wine 2 | −14 | −35 | 0 | −7 | −17 | −30 | −25 |
| Apple Juice | −16 | −22 | 0 | −3 | −5 | −18 | −8 |
| Peach Juice | −1 | −6 | 0 | −1 | −3 | −9 | −9 |
| Average SRI | −7 | −18 | 0 | −1 | −5 | −14 | −10 |

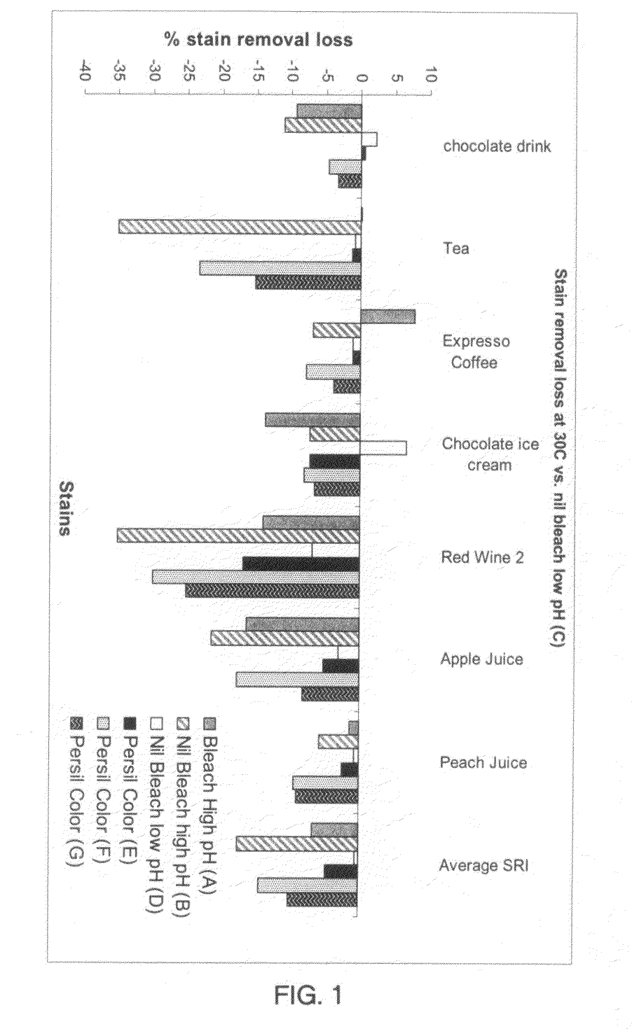

Detergent formulation C is a simplified formulation at low pH. This formulation comprises protease, but does not comprise other enzymes, as these can, in some cases, help in the removal of aid in the removal of bleachable soils. Thus we have removed enzyme, other than amylase from the reference formulation of the present invention so as to be, single variably, clear of the benefit of the formula without other bleachable soils removing aids. Composition B is the equivalent composition, but at high pH. Composition D is another example of a low pH formula of the present invention, without performance boosting ingredients. Compositions E, F and G are competitor nil-bleach formulae we purchased from the market and tested. We are not able to specify the ingredients and levels thereof, as this is impossible to analyse accurately. As can be seen from the above tabulated data, as well as in the plot of “Stain Removal Loss at 30c vs. Nil Bleach Low pH (C) in FIG. 1, compositions C and D clean highly coloured soils better than the equivalent nil-bleach formulation at high pH (B) and the competitor products currently available on the market. This was indeed surprising as it was expected that compositions C and D would perform badly because of the loss of high pH cleaning ability. Moreover and even more surprisingly, the compositions of the present invention, compositions C and D, even perform better than the composition containing bleach, composition A.

### Formulations

The detergent tablet can comprise a wide variety of different ingredients, such as building agents, effervescent system, enzymes, dissolution aids, disintegrants, suds supressors, surfactants (nonionic, anionic, cationic, amphoteric, and/or zwitterionic), fabric softening agents, colorants, perfumes and perfume particles, lime soap dispersants, organic polymeric compounds including polymeric dye transfer inhibiting agents, dye locking agents, crystal growth inhibitors, anti-redeposition agents, soil release polymers, hydrotropes, fluorescents, heavy metal ion sequestrants, metal ion salts, enzyme stabilisers, corrosion inhibitors, optical brighteners, and combinations thereof.

When formulated as compositions suitable for use in a laundry machine washing method, the compositions herein typically contain a surfactant and preferably a builder compound and additionally one or more detergent components preferably selected from organic polymeric compounds, additional enzymes, suds suppressors, dispersants, lime-soap dispersants, perfume and perfume particles, soil suspension and anti-redeposition agents and corrosion inhibitors. Laundry compositions can also contain softening agents, as additional detergent components. Particularly preferred additional ingredients include perfume particles, particularly those described in the Applicants co-pending European patent application number 04447060.7.

The compositions herein can also be used as detergent additive products. Such additive products are intended to supplement or boost the performance of conventional detergent compositions and can be added at any stage of the cleaning process.

The detergent tablets of the present invention are made by tabletting a detergent base powder. The base powder is typically a pre-formed detergent granule. The pre-formed detergent granule may be an agglomerated particle or in any other form. The average particle size of the base powder is typically from 100 μm to 2,000 μm, preferably from 200 μm, or from 300 μm, or from 400 μm, or from 500 μm and preferably to 1,800 μm, or to 1,500 μm, or to 1,200 μm, or to 1,000 μm, or to 800 μm, or to 700 μm. Most preferably, the average particle size of the base powder is from 400 μm to 700 μm. The bulk density of the base powder is typically from 400 g/l to 1,200 g/l, preferably from 500 g/l to 950 g/l, more preferably from 600 g/l to 900 g/l, and most preferably from 650 g/l to 850 g/l.

### Builder Compound

When formulated in a laundry detergent tablet, the composition herein preferably comprises a builder compound, typically present at a level of from 1% to 80% by weight, preferably from 10% to 70% by weight, most preferably from 20% to 60% by weight of the composition.

Highly preferred builder compounds for use in the present invention are water-soluble phosphate builders. Specific examples of water-soluble phosphate builders are the alkali metal tripolyphosphates, sodium, potassium and ammonium pyrophosphate, sodium and potassium and ammonium pyrophosphate, sodium and potassium orthophosphate, sodium polymeta/phosphate in which the degree of polymerisation ranges from 6 to 21, and salts of phytic acid.

Examples of partially water soluble builders include the crystalline layered silicates as disclosed for example, in EP-A-0164514, DE-A-3417649 and DE-A-3742043. Examples of largely water insoluble builders include the sodium aluminosilicates. Suitable aluminosilicates include the aluminosilicate zeolites having the unit cell formula Na_{z}[(AlO₂)_{z}(SiO₂)y]·H₂O wherein z and y are at least 6; the molar ratio of z to y is from 1.0 to 0.5 and x is at least 5, preferably from 7.5 to 276, more preferably from 10 to 264. The aluminosilicate material are in hydrated form and are preferably crystalline, containing from 10% to 28%, more preferably from 18% to 22% water in bound form.

### Disintegration Aid

It is preferred that the detergent tablets herein comprise a disintegration aid, such as:

1. The compositions herein can comprise a disintegrant that will swell on contact with water. Possible disintegrants for use herein include those described in the Handbook of Pharmaceutical Excipients (1986). Examples of suitable disintegrants include clays such as bentonite clay; starch: natural, modified or pregelatinised starch, sodium starch gluconate; gum: agar gum, guar gum, locust bean gum, karaya gum, pectin gum, tragacanth gum; croscarmylose sodium, crospovidone, cellulose, carboxymethyl cellulose, algenic acid and its salts including sodium alginate, silicone dioxide, polyvinylpyrrolidone, soy polysaccharides, ion exchange resins, and mixtures thereof.

2. Preferably the tablets will be coated so that the tablet does not absorb moisture, or absorbs moisture at only a very slow rate. The coating can improve the mechanical characteristics of a shaped composition while maintaining or improving dissolution. This very advantageously applies to multi-layer tablets, whereby the mechanical constraints of processing the multiple phases can be mitigated though the use of the coating, thus improving mechanical integrity of the tablet. The preferred coatings and methods for use herein are described on page 3, line 28 to page 4, line 12 of EP-A-846,754 (published by the Procter & Gamble Company on Jun. 10, 1998). As specified therein, preferred coating ingredients are for example dicarboxylic acids. Particularly suitable dicarboxylic acids are selected from oxalic acid, malonic acid, succinic acid, glutaric acid, adipic acid, pimelic acid, suberic acid, azelaic acid, sebacic acid, undecanedioic acid, dodecanedioic acid, tridecanedioic acid and mixtures thereof. Most preferred is adipic acid. Preferably the coating comprises a disintegrant, as described hereinabove, that will swell on contact with water and break the coating into small pieces. Preferably the coating comprises a cation exchange resins, such as those sold by Purolite under the names Purolite® C100NaMR, a sodium salt sulfonated poly(styenedivinylbenzene) co-polymer and Purolite® C100CaMR, a calcium salt sulfonated poly(styene-divinylbenzene) co-polymer.

3. The compositions herein can comprise an effervescent. As used herein, effervescency means the evolution of bubbles of gas from a liquid, as the result of a chemical reaction between a soluble acid source and an alkali metal carbonate, to produce carbon dioxide gas. The addition of this effervescent to the detergent improves the disintegration time of the compositions. The amount will preferably be from 0.1% to 20%, more preferably from 5% to 20% by weight of composition. Preferably the effervescent should be added as an agglomerate of the different particles or as a compact, and not as separate particles.

4. Further dispersion aid could be provided by using compounds such as sodium acetate, nitrilotriacetic acid and salts thereof or urea. A list of suitable dispersion aid may also be found in Pharmaceutical Dosage Forms: Tablets, Vol. 1, 2nd Edition, Edited by H. A. Lieberman et al, ISBN 0 8044 5. Non-gelling binding can be integrated to the particles forming the tablet in order to facilitate dispersion. They are preferably selected from synthetic organic polymers such as polyethylene glycols, polyvinylpyrrolidones, polyacetates, water-soluble acrylate copolymers, and mixtures thereof. The handbook of Pharmaceutical Excipients; 2nd Edition has the following binder classification: Acacia, Alginic Acid, Carbomer, Carboxymethylcellulose sodium, Dextrin, Ethylcellulose, Gelatin, Guar Gum, Hydrogenated vegetable oil type 1, Hydroxyethyl cellulose, Hydroxypropyl methylcellulose, Liquid glucose, Magnesium aluminum silicate, Maltodextrin, Methylcellulose, polymethacrylates, povidone, sodium alginate, starch and zein. Most preferred binder also have an active cleaning function in the wash such as cationic polymers. Examples include ethoxylated hexamethylene diamine quaternary compounds, bishexamethylene triamines or other such as pentaamines, ethoxylated polyethylene amines, maleic acrylic polymers. Preferred binders of the present tablets are natural Sugars, such as Neosorb available from Roquette.

5. The compositions herein may also comprise expandable clays. As used herein the term “expandable” means clays with the ability to swell (or expand) on contact with water. These are generally three-layer clays such as aluminosilicates and magnesium silicates having an ion exchange capacity of at least 50 meq/100 g of clay. The three-layer expandable clays used herein are classified geologically as smectites. Example clays useful herein include montmorillonite, volchonskoite, nontronite, hectorite, saponite, sauconitem, vermiculite and mixtures thereof. The clays herein are available under various 5 tradenames, for example, Thixogel #1 and Gel white GP from Georgia Kaolin Co., Elizabeth, N.J., USA; Volclay BC and Volclay #325 from American Colloid Co., Skokie, Ill., USA; Black Hills Bentonite BH450 from International Minerals and Chemicals; and Veegum Pro and Veegurn F, from R. T. Vanderbilt. It is to be recognised that such smectite-type minerals obtained under the foregoing tradenames can comprise mixtures of the various discrete mineral entities. Such mixtures of the smectite minerals are suitable for use herein.

6. The compositions of the present invention may comprise a highly soluble compound. Such a compound could be formed from a mixture or from a single compound. Examples include salts of acetate, urea, citrate, phosphate, sodium diisobutylbenzene sulphonate (DIBS), sodium toluene sulphonate, and mixtures thereof.

7. The compositions herein may comprise a compound having a Cohesive Effect on the detergent matrix forming the composition. The Cohesive Effect on the particulate material of a detergent matrix forming the tablet or a layer of the tablet is characterised by the force required to break a tablet or layer based on the examined detergent matrix pressed under controlled compression conditions. For a given compression force, a high tablet or layer strength indicates that the granules stuck highly together when they were compressed, so that a strong cohesive effect is taking place. Means to assess tablet or layer strength (also refer to diametrical fracture stress) are given in Pharmaceutical dosage forms: tablets volume 1 Ed. H. A. Lieberman et al, published in 1989. The cohesive effect is measured by comparing the tablet or layer strength of the original base powder without compound having a cohesive effect with the tablet or layer strength of a powder mix which comprises 97 parts of the original base powder and 3 parts of the compound having a cohesive effect. The compound having a cohesive effect is preferably added to the matrix in a form in which it is substantially free of water (water content below 10% (pref. below 5%)). The temperature of the addition is between 10 and 800° C., more pref. between 10 and 400° C. A compound is defined as having a cohesive effect on the particulate material according to the invention when at a given compacting force of 3000N, tablets with a weight of 50 g of detergent particulate material and a diameter of 55 mm have their tablet tensile strength increased by over 30% (preferably 60 and more preferably 100%) by means of the presence of 3% of the compound having a cohesive effect in the base particulate material. An example of a compound having a cohesive effect, is sodium diisoalkylbenzene sulphonate.

### Alkalinity

In a further preferred embodiment, the composition comprises less than 10% alkaline or alkaline earth metal carbonate, silicate, metasilicate or other alkalinity providing ingredients.

### Detergent Tablet Making Process

The detergent tablets of the present invention can be dosed to the laundry machine via the drawer or directly into the drum, potentially via a dispending device, such as a net.

Tablets can be prepared simply by mixing the solid ingredients together and compressing the mixture in a conventional tablet press as used, for example, in the pharmaceutical industry, in the food industry, or in the detergent industry. The detergent tablets can be made in any size or shape and can, if desired, be coated. The particulate materials used for making the tablet can be made by any particulation or granulation process. An example of such a process is spray drying (in a co-current or counter current spray drying tower) which typically gives low bulk densities 600 kg/m³ or lower. Particulate materials of higher density can be prepared by granulation and densification in a high shear batch mixer/granulator or by a continuous granulation and densification process (e.g. using Lödige™ CB and/or Lödige™ KM mixers). Other suitable processes include fluid bed processes, compaction processes (e.g. roll compaction), extrusion, as well as any particulate material made by any chemical process like flocculation, crystallisation sentering, etc. Individual particles can also be any other particle, granule, sphere or grain.

The particulate materials may be mixed together by any conventional means. Batch is suitable in, for example, a concrete mixer, Nauta mixer, ribbon mixer or any other. Alternatively the mixing process may be carried out continuously by metering each component by weight on to a moving belt, and blending them in one or more drum(s) or mixer(s). A binder, preferably a non-gelling binder; can be sprayed on to the mix of some, or, on the mix of all of the particulate materials, either separately or premixed. For example perfume and slurries of optical brighteners may be sprayed. A finely divided flow aid (dusting agent such as zeolites, carbonates, silicas) can be added to the particulate materials after spraying the binder, preferably towards the end of the process, to make the mix less sticky.

The tablets may be manufactured by using any compacting process, such as tabletting, briquetting, or extrusion, preferably tabletting. Suitable equipment includes a standard single stroke or a rotary press (such as Courtoy™, Korch™, Manesty™, or Bonals™). Tablets prepared should preferably have a diameter of between 40 mm and 60 mm, and a weight between 25 and 100 g. The ratio of height to diameter (or width) of the tablets is preferably greater than 1:3, more preferably greater than 1:2. The compaction pressure used for preparing these tablets need not exceed 5000 kN/m, preferably not exceed 3000 kN/m, and most preferably not exceed 1000 kN/m.

The detergent tablet typically has a diameter of between 20 mm and 60 mm, and typically having a weight of from 10 g to 100 g. However in one embodiment of the present invention the combined weight of the tablets making up one dose should be less than 75 g, preferably less that 70 g more preferably less than 65 g. The ratio of tablet height to tablet width is typically greater than 1:3. The tablet typically has a density of at least 900 g/l, preferably at least 950 g/l, and preferably less than 2,000 g/l, more preferably less than 1,500 g/l, most preferably less than 1,200 g/l.

### Packaging

Preferably the detergent tablet of the present invention will be packaged into a humidity resistant package. It has been found that the long term stability of the tablet will be further improved by packaging the tablets with materials that provide a moisture barrier, expressed as a moisture vapor transmission rate (MVTR), of at less than 1 g H₂0/day/m², preferably less than 0.1 g H₂0/day/m², and more preferably less than 0.02 g H₂0/day/m².

The choice of packaging material for the perfumed detergent tablet of the present invention can be determined by following several steps. First determine the critical amount of water that can be adsorbed or absorbed by the perfumed detergent tablet without losing performance, where the loss of performance can be quantified by the level of perfume components in the headspace above or on the dried fabrics, by the incomplete dissolution of the composition/article, etc. Water absorption may be determined by exposing the composition/article to constant humidity and determining the mass gained over time. Then, evaluate the performance (analytical and/or sensory) of each perfumed detergent tablet to determine the critical quantity of water. Second, determine the surface area of the package in which the perfumed tablets will be packaged and sold in the trade. Third, determine the in-trade stability requirement, such as the number of months that the detergent tablet is likely to remain in the package prior to use. The maximum moisture vapour tansmission rate (MVTR) for the detergent tablet may be calculated using the following equation:

MVTR=(Critical Mass of Water)/(Surface Area of Package)/(in-trade stability required)[=]g H₂O/m²/day.

Tabulated values of MVTR provided in technical references generally report data determined at 28-38° C., and 80%-90% relative humidity such that they represent worse case scenario ambient conditions. Selecting the packaging material under these conditions will ensure long term stability of the article. Preferably, the article is packaged so that moisture penetration must occur through a continuous layer, and the moisture vapour transmission rate of the layer is less than 1 g H₂O/m²/day, Preferably less than 0.5 g H₂O/m²/day, more preferably less than 0.1 g H₂O/m²/day, even more preferably less than 0.02 g H₂O/m²/day and still more preferably 0 g H₂O/m²/day, to ensure article stability.

The packaging system comprises at least a micro-hole. There may also be more than 1 micro-hole. These can be made using a pin. An advantage of using a micro-hole in combination of a material having the claimed MVTR is that the problem of ingress of moisture and the problem of evacuation of gas can be decoupled. Indeed the ingress of moisture is readily controlled by choosing the right MVTR, whereas a micro-hole has only a negligible influence on ingress of moisture because it is present only at some points on the packaging system without modifying the characteristics of the remaining surface of the packaging system and a microhole will not have influence enough if there is no pressure gradient. As a pressure gradient will appear precisely when gas needs to be evacuated to prevent deformation of the packaging system the micro-hole will fulfil its function without significant influence on the ingress of moisture.

The tablets of the invention can be wrapped after being deposed onto the packaging system. A cold seal or an adhesive is particularly suited to the packaging system of the present invention. Indeed a band of cold seal or a band of adhesive may be applied to the surface of the packaging system at a position adjacent to the second end of the packaging system, so that this band may provide the initial seal of the packaging system. In such a case the cold seal band may correspond to a region having a cohesive surface, i.e., a surface which will adhere only to another cohesive surface.

### EXAMPLES

The following represent examples of compositions according to the present invention. The compositions are then tabletted and packed as described above. They are in no way meant to be limiting of the scope of the invention.

| Tablet | L | M | N | O | P | Q |
|---|---|---|---|---|---|---|
| Composition | (%) | (%) | (%) | (%) | (%) | (%) |
| Surfactants | | | | | | |
| Linear Alkyl | 10.5 | 10.5 | 10.5 | 13.0 | 13.0 | 13.0 |
| benzene | | | | | | |
| sulphonates | | | | | | |
| Alkyl Ether | | | | | | |
| Sulphates | | | | | | |
| Alkyl Sulphates | 3.0 | | 3.0 | 4.0 | | 4.0 |
| Ethers of fatty | 3.5 | 4.5 | 3.5 | 4.5 | 5.0 | 4.5 |
| alcohols | | | | | | |
| Builder/buff./Disso | | | | | | |
| Sodium Citrate | 5.0 | | | 15.0 | 10.0 | 0.0 |
| Zeolite A | 25.0 | 25.0 | 10.0 | 25.0 | 25.0 | 10.0 |
| STPP | | | 40.0 | | | 35.0 |
| Sodium Carbonate | 5.0 | 5.0 | 5.0 | 6.0 | 6.0 | 5.0 |
| Silcate | 2.0 | 10.0 | 2.0 | 2.0 | 10.0 | 2.0 |
| Sodium Acetate | | 12.0 | | | 5.0 | |
| Citric Acid | | | 5.0 | | | 5.0 |
| Bleach/Chelant | | | | | | |
| phosphonate | 0.5 | 0.5 | 0.5 | 0.5 | | |
| Polymers | | | | | | |
| Acrylic/Maleic | 1.0 | 1.0 | 1.0 | 1.0 | 1.0 | 1.0 |
| copolymer | | | | | | |
| Dye transfert | 1.0 | 1.0 | 1.0 | 1.0 | 1.0 | 1.0 |
| inhibitor polymer | | | | | | |
| Soil release | 0.2 | 0.2 | 0.2 | 0.2 | 0.2 | 0.2 |
| polymer | | | | | | |
| carboxymethyl | 2.0 | 2.0 | 2.0 | 2.0 | 2.0 | 2.0 |
| cellulose polymer | | | | | | |
| Softner | | | | | | |
| Clay | | 3.0 | | | 3.0 | |
| Enzymes | | | | | | |
| Amylase | 0.2 | 0.2 | 0.2 | 0.3 | 0.3 | 0.3 |
| Cellulase | 0.1 | 0.1 | 0.1 | 0.1 | 0.1 | 0.1 |
| Lipase | 0.2 | 0.2 | 0.2 | 0.2 | 0.2 | 0.2 |
| Protease | 0.4 | 0.4 | 0.4 | 0.5 | 0.5 | 0.5 |
| Perfume/aesthetics | | | | | | |
| Perfume | 0.5 | 0.5 | 0.5 | 0.6 | 0.6 | 0.6 |
| Binders and | | | | | | |
| others | | | | | | |
| suds supressor | 2.0 | 2.0 | 2.0 | 2.0 | 2.0 | 2.0 |
| Arbocel | 6.0 | | | 6.0 | | |
| Soap | 1.0 | 1.0 | 1.0 | 1.0 | 1.0 | 1.0 |
| Moisture | 10.0 | 10.0 | 10.0 | 10.0 | 10.0 | 10.0 |
| Sulphate | Balance to | Balance to | Balance to | Balance to | Balance to | Balance to |
| | 100 | 100 | 100 | 100 | 100 | 100 |

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

All documents cited in the Detailed Description of the Invention are, in relevant part, incorporated herein by reference; the citation of any document is not to be construed as an admission that it is prior art with respect to the present invention. To the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A bleach-free detergent tablet comprising a composition, wherein the composition provides a pH through the wash of less than about 9 and wherein the composition comprises at least about one surfactant, and has an average normalised soil removal index of greater than about minus 2.

2. A bleach-free detergent tablet according to claim 1 wherein the composition has an average normalised soil removal index of greater than about zero.

3. A bleach-free detergent tablet according to claim 1 wherein the composition comprises greater than about 10% alkaline or alkaline earth metal sulphate.

4. A bleach-free detergent tablet according to claim 1 wherein the composition comprises greater than about 15% alkaline or alkaline earth metal sulphate.

5. A bleach-free detergent tablet according to claim 1 wherein the pH through the wash is between about 7 and about 8.9.

6. A bleach-free detergent tablet according to claim 1 wherein the pH through the wash is between about 8.3 and about 8.7.

7. A bleach-free detergent tablet according to claim 1 comprising about 10% or more surfactant.

8. A bleach-free detergent tablet according to claim 1 wherein the composition comprises at least about one anionic surfactant.

9. A bleach-free detergent tablet according to claim 1 wherein the anionic surfactant is linear alkyl benzene sulphonate.

10. A bleach-free detergent tablet according to claim 1 wherein at least one surfactant is incorporated into the tablet in an agglomerate.

11. A bleach-free detergent tablet according to claim 1 wherein the composition comprises less than about 10% alkaline or alkaline earth metal carbonate, silicate, metasilicate or other alkalinity providing ingredients.

12. A bleach-free detergent tablet in the form of a kit comprising about one or more tablets, wherein the about one or more tablets comprises a composition, wherein the composition of the about one or more tablets provides a pH through the wash of less than about 9, wherein the composition comprises at least one surfactant and wherein the kit has a dosage weight of less than about 75 g.

13. A bleach-free detergent tablet according to claim 12 wherein the pH through the wash is between about 7 and about 8.9.

14. A bleach-free detergent tablet according to claim 12 wherein the pH through the wash is between about 8.3 and about 8.7.

15. A bleach-free detergent tablet according to claim 12 comprising about 10% or more surfactant

16. A bleach-free detergent tablet according to claim 12 wherein the composition comprises at least about one anionic surfactant.

17. A bleach-free detergent tablet according to claim 12 wherein the anionic surfactant is linear alkyl benzene sulphonate.

18. A bleach-free detergent tablet according to claim 12 wherein at least one surfactant is incorporated into the tablet in an agglomerate.

19. A bleach-free detergent tablet according to claim 12 wherein the composition comprises less than about 10% alkaline or alkaline earth metal carbonate, silicate, metasilicate or other alkalinity providing ingredients.

20. A bleach-free detergent tablet kit according to claim 12 wherein the dosage weight is less than about 70 g.
